(19) United States
(12) Patent Application Publication
(10) Pub. No.: US 2018/0146432 A1
(43) Pub. Date: May 24, 2018

(54) SYSTEM AND METHOD FOR MODELLING DELAY PERFORMANCE OF A COMMUNICATIONS PROTOCOL

(71) Applicant: Macau University of Science and Teclmology, Taipa (MO)

(72) Inventor: Feng Li, Taipa (MO)

(21) Appl. No.: 15/356,764

(22) Filed: Nov. 21, 2016

(51) Int. Cl. H04W 52/02

(52) U.S. Cl. CPC H04W 52/0261; H04W 52/0212

(57) ABSTRACT

A system and method for modelling delay performance of a communications protocol including the steps of: applying a queuing model to a communications protocol having a power management scheme capable of affecting the delay performance of the communications protocol when in use; wherein the application of the queuing model to the communications protocol is arranged to model an operation of the communications protocol and the power management scheme so as to determining one or more operation intervals of the modelled operation of the communications protocol; and calculating the delay performance with the one or more determined operation intervals.

### TECHNICAL FIELD

The present invention relates to a system and method for modelling the delay performance of a communications protocol, and particularly, although not exclusively, to modelling the delay performance of a communications protocol having a power management scheme.

### BACKGROUND

Network designers have been designing communication networks to operate efficiently since the beginning of telecommunications. In the 1970's engineers first considered the problem of a shared medium for multiple client transmissions, in which unless a shared medium was properly shared and its access by clients controlled, collisions stemming from multiple clients transmitting at the same time would result in corrupt and unintelligible messages.

Since the 1970's Engineers have developed further improvements to telecommunications protocol so as to handle contentions within a shared telecommunications medium. An example of a more modern telecommunication protocol is the IEEE 802.11 standard, which is a set of media access control (MAC) and physical layer (PHY) specifications for wireless networking includes specific operating protocols which allow multiple clients to properly share the transmission medium.

Despite these advances, efficiency of network resources and the ability to handle an increasing number of telecommunication clients continue to be a challenge to engineers. With a growing number of more sophisticated devices with ever growing demands for telecommunications, engineers are constantly trying to improve the operating efficiency of telecommunications network.

### SUMMARY OF THE INVENTION

In accordance with a first aspect of the present invention, there is provided a method for modelling delay performance of a communications protocol comprising the steps of:
applying a queuing model to a communications protocol having a power management scheme capable of affecting the delay performance of the communications protocol when in use; wherein the application of the queuing model to the communications protocol is arranged to model an operation of the communications protocol and the power management scheme so as to determining one or more operation intervals of the modelled operation of the communications protocol; and
calculating the delay performance with the one or more determined operation intervals.

In an embodiment of the first aspect, the queuing model is a pure limited service system model.

In an embodiment of the first aspect, the step of applying the pure limited service system model to the communications protocol to model an operation of the communications protocol includes a step of applying modelled parameters of the communications protocol to associated queuing parameters of the pure limited service system model.

In an embodiment of the first aspect, the one or more operation intervals include:
one or more delay intervals of each communication station's interaction with an access point;
one or more service time of the each communication station's interaction with the access point;
one or more waiting time of each communication station's interaction with the access point; or any one or more thereof.

In an embodiment of the first aspect, the queuing parameters of the pure limited service system model include:
one or more vacation parameters representative of one or more vacation intervals; and
one or more service parameters representative of one or more service intervals.

In an embodiment of the first aspect, the modelled parameters of the communications protocol include:
one or more actual polling intervals between an actual polling point of an associated station and its next actual or virtual polling point; and
one or more virtual polling interval between a virtual polling point of an associated station and its next actual or virtual polling point.

In an embodiment of the first aspect, the one or more operation intervals of the modelled operation of the communications protocol is determined with the one or more vacation parameters representative of one or more vacation intervals and the one or more virtual polling interval between a virtual polling point of an associated station and its next actual or virtual polling point.

In an embodiment of the first aspect,
the one or more vacation parameters of the queuing model is associated to the one or more virtual polling interval between a virtual polling point of an associated station and its next actual or virtual polling point;
the one or more service parameters is calculated by using the one or more actual polling intervals between an actual polling point of an associated station and its next actual or virtual polling point.

In an embodiment of the first aspect, the mathematical representation of the delay performance includes an average and deviation of the one or more delay intervals.

In an embodiment of the first aspect, the method is used in a network management process to model an operation of a computer or communication network.

In an embodiment of the first aspect, the communications protocol is a wireless communications protocol.

In accordance with a second aspect of the present invention, there is provided a system for modelling delay performance of a communications protocol comprising:
a modelling processor arranged to apply a queuing model to a communications protocol having a power management scheme capable of affecting the delay performance of the communications protocol when in use; wherein the application of the queuing model to the communications protocol is arranged to model an operation of the communications protocol and the power management scheme so as to determining one or more operation intervals of the modelled operation of the communications protocol; and
a calculating module arranged to calculate the delay performance with the one or more determined operation intervals.

In an embodiment of the second aspect, the queuing model is a pure limited service system model.

In an embodiment of the second aspect, the modelling processor applies the pure limited service system model to the communications protocol to model an operation of the communications protocol includes a step of applying modelled parameters of the communications protocol to associated queuing parameters of the pure limited service system model.

In an embodiment of the second aspect, the one or more operation intervals include:
one or more delay intervals of each communication station's interaction with an access point;
one or more service time of the each communication station's interaction with the access point;
one or more waiting time of each communication station's interaction with the access point; or any one or more thereof.

In an embodiment of the second aspect, the queuing parameters of the pure limited service system model includes:
one or more vacation parameters representative of one or more vacation intervals; and
one or more service parameters representative of one or more service intervals.

In an embodiment of the second aspect, the modelled parameters of the communications protocol include:
one or more actual polling intervals between an actual polling point of an associated station and its next actual or virtual polling point; and
one or more virtual polling interval between a virtual polling point of an associated station and its next actual or virtual polling point.

In an embodiment of the second aspect, the one or more operation intervals of the modelled operation of the communications protocol is determined with the one or more vacation parameters representative of one or more vacation intervals (V) and the one or more virtual polling interval between a virtual polling point of an associated station and its next actual or virtual polling point.

In an embodiment of the second aspect,
the one or more vacation parameters of the queuing model is associated to the one or more virtual polling interval between a virtual polling point of an associated station and its next actual or virtual polling point;
the one or more service parameters is calculated by using the one or more actual polling intervals between an actual polling point of an associated station and its next actual or virtual polling point.

In an embodiment of the second aspect, the method is used in a network management process to model an operation of a computer or communication network.

### BRIEF DESCRIPTION OF THE DRAWINGS

Embodiments of the present invention will now be described, by way of example, with reference to the accompanying drawings in which:

FIG. 1 is a block diagram illustrating a system for modelling the delay performance of a communications protocol in accordance with one embodiment of the present invention;

FIG. 2 is a timeline diagram of an example of operation of the Point Coordinated Function (PCF) with Power Management (PM);

FIG. 3 shows, at the upper portion, a timeline diagram of an example of the classic pure limited service system with multiple vacations, and, at the lower portion, shows a timeline diagram of an example of the PCF-PM system, super-imposed onto the timeline diagram at the upper portion;

FIG. 4 is a timeline diagram of an example actual polling interval;

FIG. 5 is a timeline diagram of an example virtual polling interval;

FIG. 6 is a chart illustrating an example simulation of an example embodiment of the invention, showing the plot of the mean total delay verses the data frame arrival rate for homogenous traffic;

FIG. 7a is a chart illustrating an example of the of total delay vs. station ID for heterogeneous traffic; and,

FIG. 7b is a chart illustrating an example of the standard deviation of total delay vs. station ID for heterogeneous traffic.

### DETAILED DESCRIPTION OF THE PREFERRED EMBODIMENT

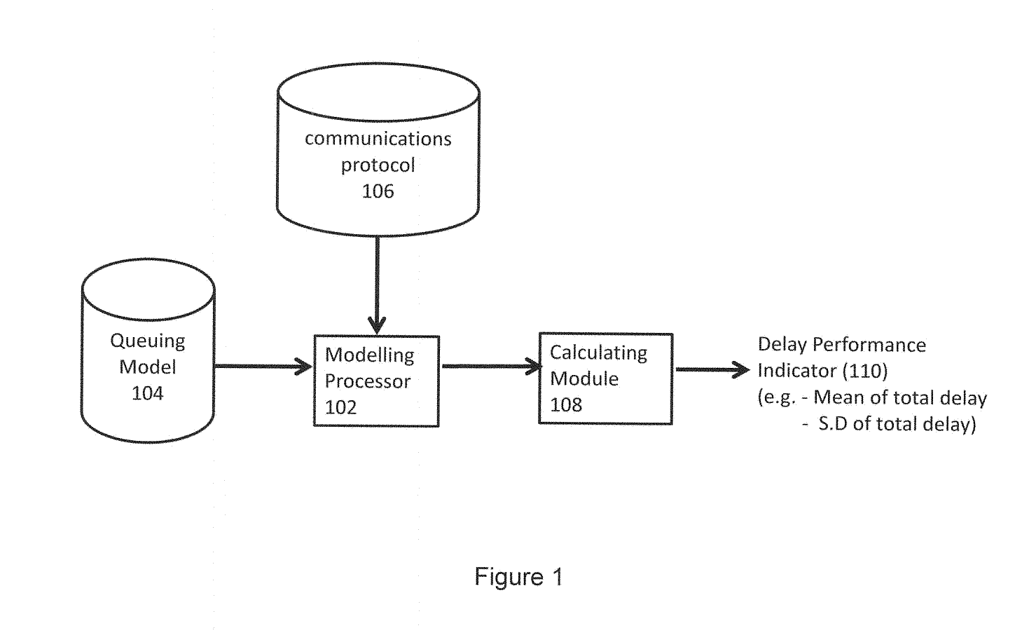

Referring to FIG. 1, there is illustrated an embodiment of a system for modelling delay performance of a communications protocol 100. In this embodiment, the system comprises: a modelling processor 102 arranged to apply a queuing model 104 to a communications protocol 106 having a power management scheme capable of affecting the delay performance of the communications protocol when in use; wherein the application of the queuing model 104 to the communications protocol 106 is arranged to model an operation of the communications protocol 106 and the power management scheme so as to determining one or more operation intervals of the modelled operation of the communications protocol 106; and a calculating module 108 arranged to calculate the delay performance 110 with the one or more determined operation intervals.

In this example embodiment, the system for modelling delay performance of a communication protocol 100 may be implemented in software, hardware or a combination of both on a computing device such as a computer, server, network controller or network management system which may have a computing storage device such as a disk or memory storage devices, computer memory and one or more central processing unit (CPU) or known as a processor. This computing device may also have communication functionality to allow the device to connect to a telecommunication system such as the internet or other forms of telecommunications system.

In this embodiment, the system for modelling delay performance 100 includes a modelling processor 102, a calculating module 108 which may be implemented as computer software on a computing device or as hardware with a programmed logic on a computing device. The modelling processor 102, in one example embodiment, is arranged to apply a queuing model 104 onto a communication protocol so as to model the operation of the communication protocol 106. In turn, this model of the operation of the communication protocol 106, which can be considered also as simulating an operation of the communication protocol 106 can allow for various performance indicators of the communication protocol to be determined. Once determined, these indicators can be further calculated by the calculation module 108 and assessed for subsequent adjustment, improvements, processing, storage or study.

In this example embodiment, the system for modelling delay performance 100 is arranged to model a communications protocol 106 with a power management scheme. When the queuing model 104 is applied to the communications protocol model, the operation characteristics of the communications protocol model, including any delay caused by the waiting time and service time that are affected by the operation of the communications protocol 106 such as (the channel access delay, frame transmission time, ACK time, and waiting delay) can be determined in the simulation and thus calculated to produce a delay performance indicator that is important to the efficiency and operation of the communications protocol. In turn, embodiments of the invention may also be implemented as software or hardware in network systems, equipments or network analytical computing devices to assess the performance of a communications network operating with a specific protocol or the operations of the protocol itself.

Without wishing to be bound by theory, the inventors have, through their own research and experimentation, found that there is a growing popularity of IEEE 802.11 wireless LANs (WLANs) in which various types of heterogeneous devices (laptops, smartphones, tablets, sensors, actuators etc.) are being deployed within a network infrastructure that uses this IEEE 802.11 communication protocol. The heterogeneity of these devices implies the heterogeneity of their traffic, that is, their application requirements, and their power saving modes are all different and independent.

The Power Management (PM) schemes of these heterogeneous devices affect the delay performance of communication protocol IEEE 802.11 PCF network with power saving within a heterogeneous environment. This is particularly observable with the heterogeneous sleeping intervals that take place with the underlying heterogeneous devices.

As part of the IEEE 802.11 PCF standard, the Point Coordinated Function (PCF) protocol with power saving is an important contention-free protocol. It has been widely extended to IEEE 802.11 hybrid coordination function controlled channel access (HCCA) and the latest 802.11ah protocol. Despite its growing popularity, the delay performance of PCF with power saving have not been considered in any significant detail by network engineers. Most previous works in this area has focused on PCF without power saving and assumes only homogenous traffic, and it is with these limitations that the performance of the PCF has been evaluated via simulation.

These works, whilst investigated throughput performance of PCF via simulations, have only analyzed the throughput, expected channel access delay and frame loss for PCF. However, all of these works have ignored the total delay (including the channel access delay, frame transmission time, ACK time, and waiting delay), where the channel access delay of a frame is the time interval between when the frame reaches the head of the MAC queue and when the frame starts being transmitted.

In accordance with one aspect of the present invention, the inventors considers a heterogeneous environment (e.g., a computer network with hetrogenous devices that are connected thereto and operates with heterogeneous frame arrival rate, frame size, and sleeping interval), and evaluate the frame's total delay of a station by applying a queuing model to a communication system operating to a specific communication protocol (e.g. the PCF system). In one example embodiment, this queuing model is a pure limited vacation system and thus its application has the effect of converting the PCF system to an equivalent pure limited vacation system. The advantage of such a process is that by using the classic delay formula, it is possible to evaluate the delay jitter performance for variance-sensitive applications such as voice over PCF and in turn, demonstrates that the inventor's work is simpler and more scalable than that of the prior art in evaluating the delay performance of a network when compared with previous works.

In 802.11 standard, when PCF and DCF coexist, time is divided into a series of repetition intervals with equal length. In each repetition interval, the system runs first in the PCF mode and then in the DCF mode. In the PCF mode, there is a point coordinator (PC) and multiple stations.

PCF defines a power management (PM) scheme to help stations conserve energy. In this scheme, a station alternates between two states: awake and doze states. In the awake state, a station is fully powered and may receive frames at any time. In the doze state, a station is unable to transmit or receive and consumes very low power. A station notifies the PC that its power management scheme is enabled and sets the listen interval (or sleeping interval) parameter. That is, in some examples, the number of the repetition intervals for which the station is in the doze state. Then the PC will buffer frames destined for the station when the station is in the doze state, and deliver one frame to the station for each repetition interval when the station is in the awake state.

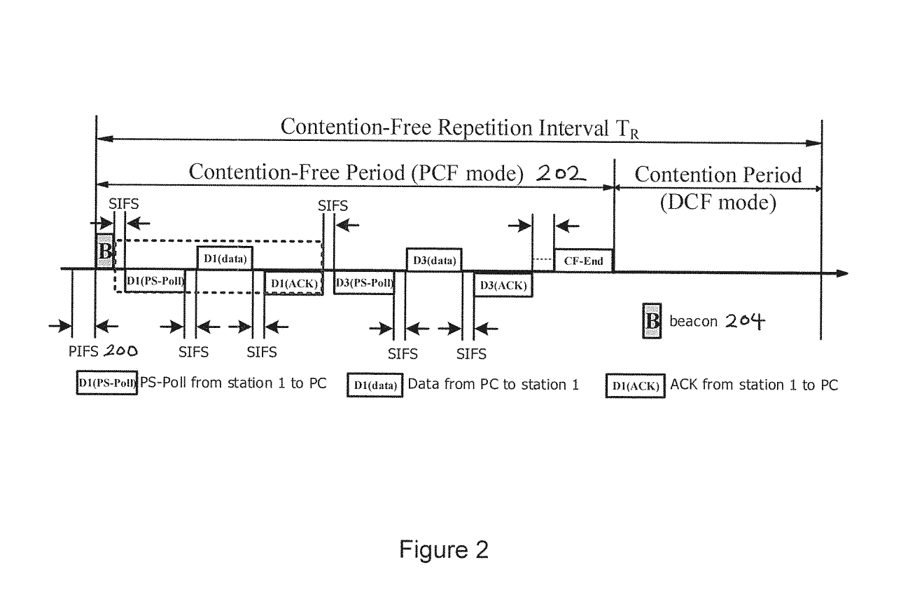

With reference to FIG. 2, there is illustrated an example of the operation process of PCF-PM. As shown, after a PCF inter frame space (PIFS) 200, the PC initializes a contention-free period (CFP) 202 by sending a beacon 204, marking the beginning of a new repetition interval. The traffic indication map (TIM) field in the beacon contains a list of the stations whose frames have been buffered at the PC. When a station wakes up at the beginning of the repetition interval, it will listen to the TIM beacon. If it finds that its ID is not indicated in the TIM beacon, it will go to sleep immediately for its listen interval. If it finds that its ID is indicated in the TIM beacon, it will keep awake until its turn, and then it begins receiving its buffered frame from the PC by following the pattern:
SIFS/PS-Poll/SIFS/Data/SIFS/ACK.

As it is also shown in FIG. 2, this figure illustrates that after stations 1 and 3 find them appearing in the list sequentially from the beacon, station 1 first waits for a short interframe space (SIFS) 206, and then begins sending a polling frame [D1 (PS-Poll)] to the PC. Upon polled, the PC sends one data frame [D1 (data)] to station 1 after a SIFS time. Receiving the data frame, station 1 send back an ACK [D1 (ACK)] to the PC. The process repeats until all stations in the list has polled the PC. Finally, the PC sends a CF-End control frame (CF-End), marking the end of the current CFP. Hereafter, the system enters the DCF mode, in which the stations in the list can no longer receive data frames until the next repetition interval starts.

To introduce the queuing model which will be applied to the PCF-system, in this example embodiment, it is preferred that the queuing model is a pure limited vacation system. This classic pure limited service system with multiple vacations is described in “H. Takagi. Queueing analysis: Volume 1. North-Holland Amsterdam, 1991”, and operates as a single-server queueing system with infinite buffer. In this queuing model or system, customers arrive according to a Poisson process with rate λ, and the customer service times have a general distribution.

In this system, the server serves only one customer each time if any and then takes vacation immediately no matter how many customers waiting in the queue. Whenever the server returns from the ongoing vacation and finds no customers waiting in the queue, it will go on a new vacation; and therefore the server is said to take multiple vacations. According to the number of customers served before the server takes vacations, it is possible to classify the vacations into two types: type 1 vacation with length V₁ (i.e., the vacation after a customer is served), and type 2 vacation with length V₂ (i.e., the vacation if no customer is served).

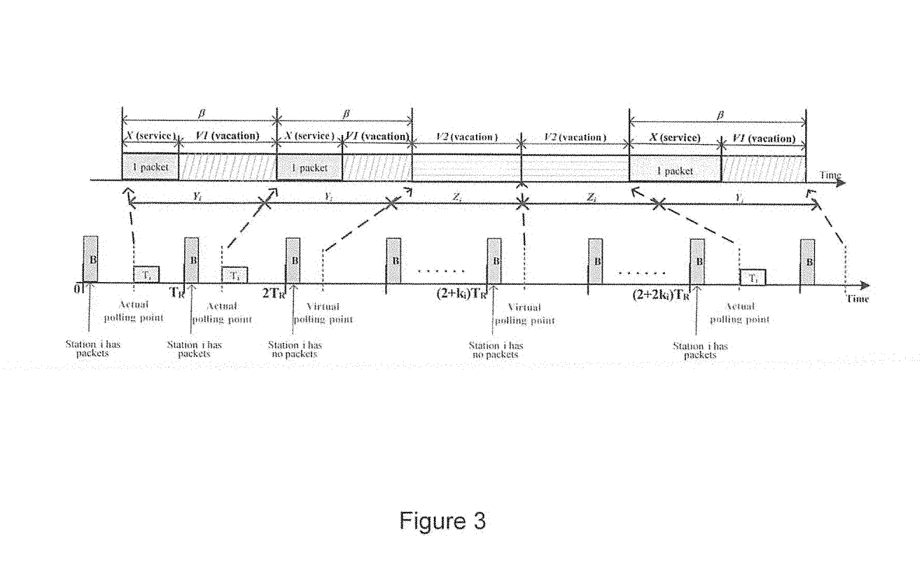

With reference to FIG. 3, upper portion, there is illustrated an example of where the server first takes two type 1 vacations sequentially, and then goes on two type 2 vacations consecutively before it begins serving a new customer. Now, assuming that customers are served in the order they arrive.

Let X be the service time of a customer.

Let β=X+V₁, and let W represent the waiting time of a customer before it is served.

Let W*(s), β*(s), and V*₂ (s), respectively, represent the Laplace transforms of the random variables W, β, and V₂. From the teachings of “H. Takagi, Queueing analysis: Volume 1, North-Holland Amsterdam, 1991” which outlines this queueing model at Section 2.6, W*(s) is given by

$${W}^{*} ( s ) = \frac{1 - λ E \{ β \}}{λ E \{ {V}_{2} \}} \cdot \frac{{V}_{2}^{*} ( s ) - 1}{1 - \frac{s}{λ} - {β}^{*} ( s )} . \qquad ( 1 )$$

Note that

E{Wⁿ}=(−1)ⁿ(W*(s))ₛ₌₀⁽ⁿ⁾,

E{βⁿ}=(−1)ⁿ(β*(s))ₛ₌₀⁽ⁿ⁾, and

E{V₂ⁿ}=(−1)ⁿ(V*₂(s))ₛ₌₀⁽ⁿ⁾

by the basic property of Laplace transform. Thus it is possible to calculate E{W} and E{W²} as follows:

$$\begin{matrix} E \{ W \} = {f}_{1} ( λ , ρ , β , {V}_{2} ) {=}^{Δ} \frac{λ E \{ {β}^{2} \}}{2 ( 1 - ρ )} + \frac{E \{ {V}_{2}^{2} \}}{2 E \{ {V}_{2} \}} , & ( 2 ) \\ and & \\ E \{ {W}^{2} \} = {f}_{2} ( λ , ρ , β , {V}_{2} ) {=}^{Δ} \frac{λ E ( {β}^{3} \}}{3 ( 1 - ρ )} + \frac{{[ λ E \{ {β}^{2} \} ]}^{2}}{2 {( 1 - ρ )}^{2}} + \frac{λ E \{ {β}^{2} \} E \{ {V}_{2}^{2} \}}{2 ( 1 - ρ ) E \{ {V}_{2} \}} + \frac{E \{ {V}_{2}^{3} \}}{3 E \{ {V}_{2} \}} . & ( 3 )\end{matrix}$$

where E{⋅} denotes the mean of ⋅ and the traffic intensity p=λE{β}.

In one example embodiment of this invention, the examples focus on the downlink traffic from the PC to stations, and thus there is a study of the delay performance of PCF with power management.

Let T_{R} denote the length of a repetition interval. For each station i (1≤i≤n), thus assume that the downlink traffic is a Poisson process with parameter λᵢ, the data frame length is Lᵢ, and the listen interval is kᵢT_{R}, where kᵢ is a positive integer.

Let Dᵢ denote the total delay of a tagged data frame of station i, where the total delay is defined to be the interval between when the tagged data frame arrives at the AP's MAC buffer and when the AP receives the ACK from the station i who receives the tagged frame. Let Wᵢ denote the waiting time of the tagged packet of station i, where the waiting time is defined to be the interval between when the tagged data frame arrives at the AP's MAC buffer and when the AP starts to service station i. Let Tᵢ denote the service time of the tagged data frame of station i, where the service time is defined to be the interval between when the AP starts to service station i (i.e., the instant after which station i first waits for a SIFS time and then sends a PS-Poll message to request its buffered frame from the AP) and when the AP receives the ACK from the station i. Then, Dᵢ is the sum of Wᵢ and Tᵢ, namely,

Dᵢ=Wᵢ+Tᵢ, 1≤i≤n. (4)

Note that the service process of a data frame follows the pattern: SIFS/PS-Poll/SIFS/Data /SIFS/ACK, as illustrated in FIG. 2. It can calculate Tᵢ as follows.

Tᵢ3T_{SIFS}+T_{PS-Poll}+T_{frame,i}+T_{ACK}, (5)

where T_{SIFS} denotes the SIFS time, T_{PS-Poll} denotes the PS-Poll time, T_{frame,i} denotes the transmission time of a data frame with length Lᵢ, and T_{ACK} denotes the transmission time of the ACK frame.

Let E(Dᵢ) and Dev{Dᵢ} represent the mean and the standard deviation of the delay Dᵢ, respectively. Thus it is derived that

E(Dᵢ)=E{Wᵢ}+Tᵢ, 1≤i≤n, Dev{Dᵢ}=Dev{Wᵢ}=\sqrt{E{Wᵢ²}−(E{Wᵢ})²}. (6)

The remaining task is to calculate E{Wᵢ} and E{Wᵢ²}. In this example embodiment of the invention, this can be achieved by modelling the PCF-PM system as a pure limited vacation system and then derive the expressions of E{Wᵢ} and E{Wᵢ²} from the classic queuing formulas (2) and (3) mentioned above.

### Applying the Equivalent Pure Limited Vacation System to the PCF-PM

In order to apply the pure limited vacation system (queuing model) to the PCF-PM (communication protocol) so as to convert the PCF-PM system into an equivalent pure limited vacation system (and then express E{Wᵢ} and E{Wᵢ²} of the PCF-PM system). It may be preferable to start describing the equivalent relationship from the receiving process that the station receives a frame from the AP.

Consider a station i in PCF-PM. Regard station i as a server. Regard the frames (arriving from the AP to station i) as the customers of the server, where frame arrivals follow a Poisson process with parameter λᵢ. When station i wakes up, it will receive a frame if it find that its TIM beacon contains its ID, or will not otherwise; equivalently speaking, station i will actually serve a customer for a duration of Tᵢ if it find that its TIM beacon contains its ID, or will virtually serve a customer for a duration of 0 (i.e., station i will not serve a customer) otherwise.

Define the actual (virtual) polling point of a station i, to be the instant that station i begins serving a frame actually (virtually), namely, the instant after the previous i-1 stations actually or virtually serve frames. The actual (virtual) polling points are illustrated in FIG. 3, lower portion.

Let Yᵢ represent the actual polling interval between an actual polling point of station i and its next actual or virtual polling point. According to PCF-PM, a station will receive only one frame in the interval Yᵢ.

Let Zᵢ represent the virtual polling interval between a virtual polling point of station i and its next actual or virtual polling point. According to PCF-PM, a station will not receive any frame in the interval Zᵢ.

Therefore, in an actual or virtual polling interval, station i will receive at most one frame and then it either keeps idle or goes to sleep; equivalently speaking, station i goes on vacations when it either keeps idle or goes to sleep, because it will not receive any frame in that time.

As part of this model, the following rules must apply:

Equivalent pure-limited rules: The instruction in PCF-PM that a station will receive at most one frame in an actual or virtual polling interval, is naturally consistent with the pure-limited rule that the server serves only one customer each time if any.

Equivalent vacation rules: The time in PCF-PM that a station either keeps idle or goes to sleep in an actual or virtual polling interval, is naturally regarded as the vacation time in the pure-limited vacation system, where the server will not serve any customer once it takes vacation, no matter how many customers waiting in the queue. The fact that a station in PCF-PM will take another vacation if it wakes up and does not find its identify in the received beacon, is naturally consistent with the concept of multiple vacations in the pure-limited vacation system. In addition, the actual polling interval Yᵢ in PCF-PM (in which station i first serves a frame and then keeps idle) is equivalent to the interval β in the pure limited vacation system; the virtual polling interval Zᵢ in PCF-PM (in which station i goes to sleep) is equivalent to the interval V₂ in the pure limited vacation system.

In short, from the viewpoint of station i, the PCF-PM system can be regarded as an equivalent pure limited vacation system, where

β=Yᵢ,

V₂=Zᵢ. (7)

Then, from (2), (3) and (7), it can easily calculate

E{Wᵢ}=f₁(λᵢ, pᵢ, Yᵢ, Zᵢ)

E{Wᵢ²}=f₂(λᵢ, pᵢ, Yᵢ, Zᵢ), (8)

where the traffic intensity pᵢ=λᵢE{Yᵢ}.

To evaluate E{Wᵢ} and E{Wᵢ²} in (8), it is preferable to respectively calculate the n-th moment of Yᵢ and Zᵢ, where n=1,2,3.

In one example embodiment, to use a calculation module, which can be a processor programmed to execute the following steps to calculate E{Yᵢ}, E{Yᵢ²} and E{Yᵢ³}.

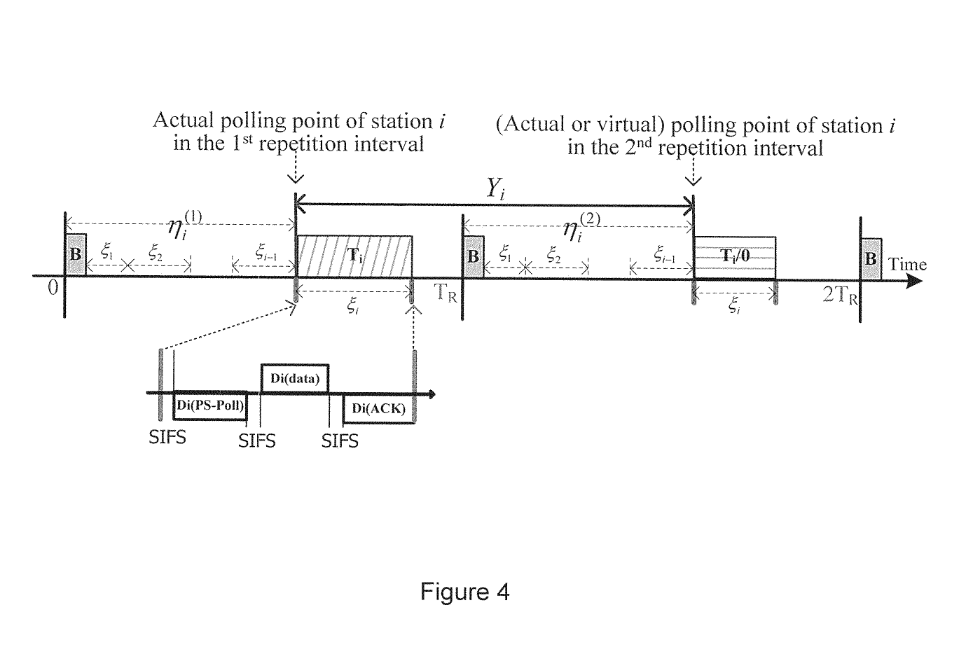

The first step is to first express Yᵢ, with the help of FIG. 4. According to the definition of Yᵢ, it is devised that.

Yᵢ=T_{R}+ηᵢ⁽²⁾−ηᵢ⁽¹⁾, 9)

where T_{R} denotes the length of a repetition interval, ηᵢ⁽¹⁾ denotes the actual polling point of station i in the first repetition interval, ηᵢ⁽²⁾ denotes the actual or virtual polling point of station i in the second repetition interval.

In this example of the model, ηᵢ⁽¹⁾ and ηᵢ⁽²⁾ are independent and identically distributed (i.i.d.) with a generic random variable ηᵢ. This can be explained in this instance with the reasoning as follows.

As illustrated in the first repetition interval in FIG. 4, station i begins its service only if station j, 1≤j≤i-1, has finished its service. Therefore, ηᵢ can be expressed as follows.

ηᵢ=T_{B}+Σⱼ₌₁ⁱ⁻¹ξⱼ, (10)

where T_{B} is the beacon transmission time and ξⱼ (1≤j≤i-1) is a random variable denoting the service time of station j. The duration of ξⱼ depends on whether station j is in the awake or doze state. Now let P_{awake,j} and P_{doze,j}, respectively, represent the probability that station j is in the awake and doze states at any arbitrary instant of time. Since ξⱼ is equal to Tⱼ if station j is in the awake state, and 0 if in the doze state, thus it can be written ξⱼ as follows.

$${ξ}_{j} = \{ \begin{matrix}{T}_{j} , & w . p . {P}_{awake , j} \\ 0 , & w . p . {P}_{doze , j}\end{matrix} . \qquad ( 11 )$$

In (11), it is essentially assumed that ξⱼ in one repetition interval is i.i.d. with that in another repetition interval. In addition, note (i) in each repetition interval, ξᵢ is independent of ξⱼ for i≢j since frame arrival to each station is independent, and (ii) the functions of independent random variables are independent as well. Thus it is concluded that ηᵢ⁽¹⁾ and ηᵢ⁽²⁾ are i.i.d. with ηᵢ.

It follows that it is possible to calculate P_{awake,j} and then P_{doze,j}, by considering the behavior of station j at every beacon that it receives. Note that station j stays in the awake state for at least T_{B} to receive a beacon. With probability pⱼ=λᵢ, E{Yⱼ}=λⱼT_{R}, station j has packets, and then it stays active for T_{R} to receive one frame and for another T_{B} to receive the next beacon. In other words, with probability pⱼ, station j stays in the awake state for T_{R}+T_{B}. With probability 1-pⱼ, station j has no packets, and then it goes into sleep and wakes up for every kⱼ-th beacon. In other words, with probability 1-pⱼ, station j stays in the awake state for T_{B}, and stays in the doze state for kⱼT_{R}−T_{B}. Then the fractions of the time that station j spends in the awake and doze states are:

$${P}_{awake , j} = \frac{{ρ}_{j} [ {T}_{R} + {T}_{B} ]}{( 1 - {ρ}_{j} ) [ {k}_{j} {T}_{R} - {T}_{B} ] + {ρ}_{j} [ {T}_{R} + {T}_{B} ]} , \\ {P}_{PS , j} = 1 - {P}_{awake , j} , where {ρ}_{j} = {λ}_{j} {T}_{R} .$$

The next step is to calculate the variance of ηᵢ, Var{ηᵢ}. From (11),

E{ξⱼ}=TⱼP_{awake,j}, E{ξⱼ²}=Tⱼ²P_{awake,j},

Var{ξⱼ}=E{(ξⱼ)²}−(E{ξⱼ})²=(Tⱼ²−Tⱼ)P_{awake,j}, (12)

Since all ξⱼs are independent each other, from (10) and (12),

Var{ηᵢ}=Σⱼ₌₁ⁱ⁻¹Var{ξⱼ}=Σⱼ₌₁ⁱ⁻¹(Tⱼ²−Tⱼ)P_{awake,j}, (13)

Finally by calculating the n-th moment of Yᵢ, where n=1,2,3.

$$\begin{matrix} E \{ {Y}_{i} \} = E \{ {T}_{R} + {η}_{i}^{( 2 )} - {η}_{i}^{( 1 )} \} = {T}_{R} , & ( 14 ) \\ And & \\ \begin{matrix} E \{ {Y}_{i}^{2} \} = E \{ {( {T}_{R} + {η}_{i}^{( 2 )} - {η}_{i}^{( 1 )} )}^{2} \} \\ = E \{ {T}_{R}^{2} + 2 {T}_{R} ( {η}_{i}^{( 2 )} - {η}_{i}^{( 1 )} ) + {( {η}_{i}^{( 2 )} - {η}_{i}^{( 1 )} )}^{2} \} \\ = {T}_{R}^{2} + E \{ {( {η}_{i}^{( 2 )} - {η}_{i}^{( 1 )} )}^{2} \} \\ = {T}_{R}^{2} + E \{ {( {η}_{i}^{( 2 )} )}^{2} - 2 {η}_{i}^{( 1 )} {η}_{i}^{( 2 )} + {( {η}_{i}^{( 1 )} )}^{2} \} \\ = {T}_{R}^{2} + 2 ( E \{ {η}_{i}^{( 2 )} \} - {( E \{ {η}_{i} \} )}^{2} ) \\ = {T}_{R}^{2} + 2 Var \{ {η}_{i} \} \\ = {T}_{R}^{2} + 2 {\sum }_{j = 1}^{i - 1} ( {T}_{j}^{2} - {T}_{j} ) {P}_{awake , j} .\end{matrix} & ( 15 ) \\ \begin{matrix}E \{ {Y}_{i}^{3} \} = E \{ {( {T}_{R} + {η}_{i}^{( 2 )} - {η}_{i}^{( 1 )} )}^{3} \} \\ = E \{ {T}_{R}^{3} + 3 {T}_{R}^{2} ( {η}_{i}^{( 2 )} - {η}_{i}^{( 1 )} ) + 3 {{T}_{R} ( {η}_{i}^{( 2 )} - {η}_{i}^{( 1 )} )}^{2} + {( {η}_{i}^{( 2 )} - {η}_{i}^{( 1 )} )}^{3} \} \\ = E \{ {T}_{R}^{3} \} + 3 {T}_{R} E \{ {( {η}_{i}^{( 2 )} - {η}_{i}^{( 1 )} )}^{2} \} + E \{ {( {η}_{i}^{( 2 )} - {η}_{i}^{( 1 )} )}^{3} \} \\ = {T}_{R}^{3} + 3 {T}_{R} \cdot 2 Var \{ {η}_{i} \} + \\ E \{ {( {η}_{i}^{( 2 )} )}^{3} - 3 {( {η}_{i}^{( 2 )} )}^{2} {η}_{i}^{( 1 )} + 3 {{η}_{i}^{( 2 )} ( {η}_{i}^{( 1 )} )}^{2} - {( {η}_{i}^{( 1 )} )}^{3} \} \\ = {T}_{R}^{3} + 6 {T}_{R} Var \{ {η}_{i} \} + E \{ {( {η}_{i} )}^{3} \} - 3 E \{ {( {η}_{i} )}^{2} \} E \{ {η}_{i} \} + \\ 3 E \{ {η}_{i} \} E \{ {( {η}_{i} )}^{2} \} - E \{ {( {η}_{i} )}^{3} \} \\ = {T}_{R}^{3} + 6 {T}_{R} Var \{ {η}_{i} \} \\ = {T}_{R}^{3} + 6 {T}_{R} {\sum }_{j = 1}^{i - 1} ( {T}_{j}^{2} - {T}_{j} ) {P}_{awake , j} .\end{matrix} & ( 16 )\end{matrix}$$

where E{(ηᵢ⁽²⁾−ηᵢ⁽¹⁾)³}=0 is used in (16).

Calculation of E{Zᵢ}, E{Zᵢ²} and E{Zᵢ³}.

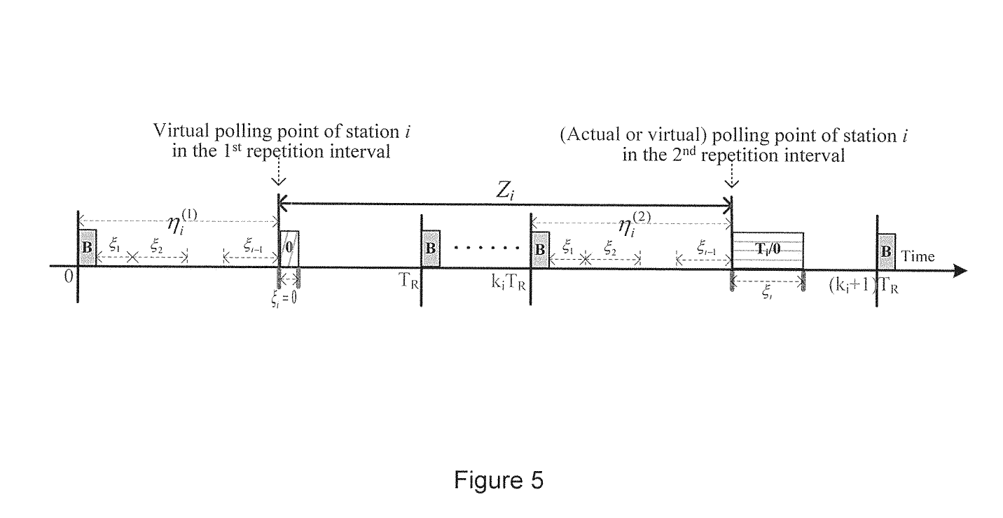

With reference to FIG. 5, it is now possible to express Zᵢ, which shows that according to the definition of Zᵢ,

Zᵢ=kᵢT_{R}+ηᵢ^{(2)-η}ᵢ⁽¹⁾, (17)

where kᵢT_{R} is the listen interval length of station i, ηᵢ⁽¹⁾ and ηᵢ⁽²⁾ are defined in (9) and are i.i.d. with ηᵢ in (10).

It is then possible to calculate the n-th momnet of Zᵢ, where n=1,2,3, following the derivation process.

E{Zᵢ}=kⱼT_{R},

E{Zᵢ²}=(kⱼT_{R})²+2Σⱼ₌₁ⁱ⁻¹(Tⱼ²−Tⱼ)P_{awake,j},

E{Zᵢ³}=(kⱼT_{R})³+6(kⱼT_{R})Σⱼ₌₁ⁱ⁻¹(Tⱼ²−Tⱼ)P_{awake,j}.

Thus with the calculation of these results, the delay performance of the network system operating with the PCF-PM protocol can be determined in the form of the Mean of total Delay and Deviation of total Delay. These calculated results of the delay performance can then be used for subsequent analysis, processing, storage or decision making by a network engineer or by a computerized network system or device.

Embodiments of this invention can be used in computing systems to analyse the delay performance of a communication protocol and thus network engineers can use embodiments of the invention to design or modify an existing or new communication protocol. Additionally, example embodiments of this invention can also be used in a network monitoring or design tool to simulate the operations of a communication network and to improve or adjust the network in real time to improve network performance. Such examples may, for example, be implemented within communications or networking equipment to provide these functionalities.

In one example embodiment of this invention, the above methods for modelling delay performance of a communications protocol comprising the steps of:

applying a queuing model to a communications protocol having a power management scheme capable of affecting the delay performance of the communications protocol when in use; wherein the application of the queuing model to the communications protocol is arranged to model an operation of the communications protocol and the power management scheme so as to determining one or more operation intervals of the modelled operation of the communications protocol; and

calculating the delay performance with the one or more determined operation intervals can be verified by a PCF-PM simulator. This simulator may be written in C++ and simulates a PCF-PM system under heterogeneous environments (i.e., heterogeneous traffic arrival rate, frame size, and listen interval).

The default parameter values shown in Table 1 below are in accordance with 802.11b.

TABLE 1
Default parameter values.

| PHY Header | =24 bytes | MACHeader | =32 bytes |
|---|---|---|---|
| RouteHeader | =20 bytes | FCS | =4 bytes |
| Tₛₗₒₜ | =20 μs | T_{SIFS} | =10 μs |
| T_{R} | =15 ms | n | =8 |
| R_{data} | =11 Mbps | R_{basic} | =1 Mbps |
| T_{PS-Poll} | =(PHYHeader + MACHeader + FCS)/R_{basic} | | |
| T_{header} | =PHYHeader/R_{basic} + (MACHeader + FCS)/R_{data} | | |
| T_{ACK} | =T_{header} | T_{B} | =209 μs |

| | |
|---|---|
| T_{frame,i} | =T_{header} + (RouteHeader + Lᵢ)/R_{data} |

where 1 slot=Tₛₗₒₜ=20 μs and time is measured in slots, the IP routing header=20 bytes, the length of the frame check sequence (FCS)=4 bytes, and the number of stations n=8. The buffer size for each station and the PC is set to 1000 data frames. Each simulation value is an average over four simulation runs, where each run was for 400 seconds.

The simulation assumes Poisson arrivals and run two experiments. In the first experiment, the simulation considers the homogeneous setting, where all stations have the same data frame arrival rate, the same data frame size of 100 bytes, and the same listen interval of 5T_{R}.

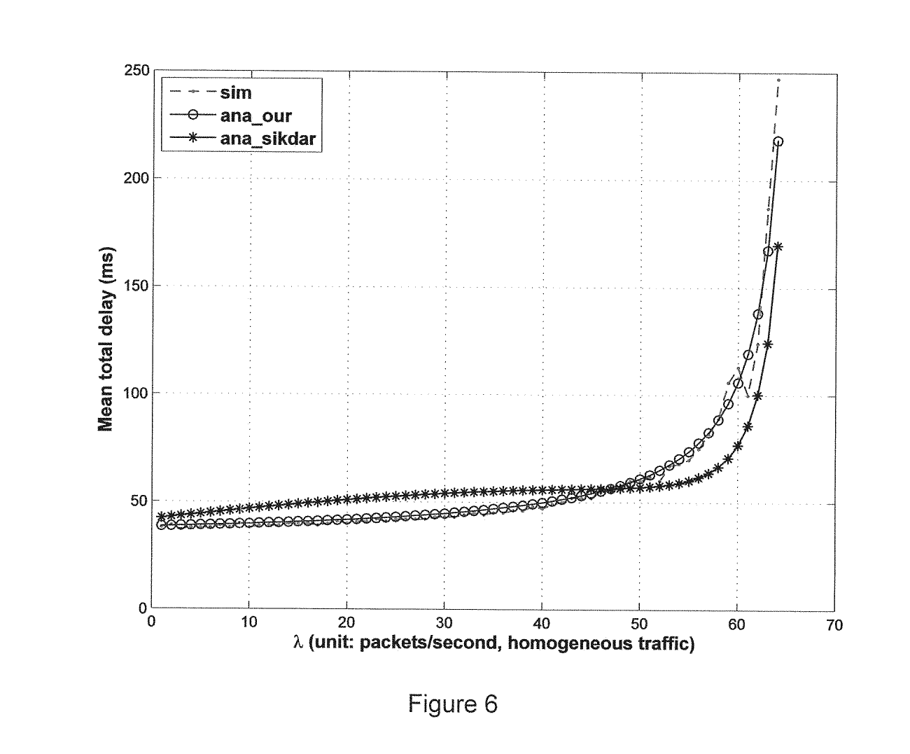

With reference to FIG. 6, there is illustrated a chart which plots the mean total delay of station 8's data frames versus the data frame arrival rate for the homogeneous traffic (note that the models described herein obtained very similar results when considering other station's data frame). The dashed curve shows the simulation results, while the solid curve labeled with “ana_our” plots the theoretical result and the solid curve labeled with “ana_sikdar” plots the theoretical result of prior art publications B. Sikdar. An Analytic Model for the Delay in IEEE 802.11 PCF MAC-based Wireless Networks. IEEE Trans. Wireless Commun., 6(4) :1542-1550, 2007. From this figure, it is observable that the results of the present invention better match with the corresponding simulation results than those in the prior art, indicating that the invention and the modelling devised from embodiments of this invention is more accurate even for the homogeneous traffic.

In another experiment, the inventors considered a heterogeneous setting. In this experiment, 8 stations are polled by PC, where stations 1 to 4 transmit voice traffic and stations 5 to 8 transmit data traffic at rate 11 Mbps (i.e., R_{data}=11 Mbps), and each station takes a different parameter setting shown in Table 2 below.

TABLE 2
Parameter values for voice traffic and data traffic.

| | voice traffic | | | | data traffic | | | |
|---|---|---|---|---|---|---|---|---|
| | Station ID | | | | | | | |
| | 1 | 2 | 3 | 4 | 5 | 6 | 7 | 8 |
| λᵢ (pkts/sec) | 16.67 | 25 | 33.33 | 50 | 20 | 30 | 40 | 50 |
| Lᵢ (bytes) | 48 | 40 | 50 | 160 | 500 | 600 | 700 | 800 |
| kᵢ (T_{R}) | 2 | 3 | 4 | 5 | 6 | 7 | 8 | 9 |

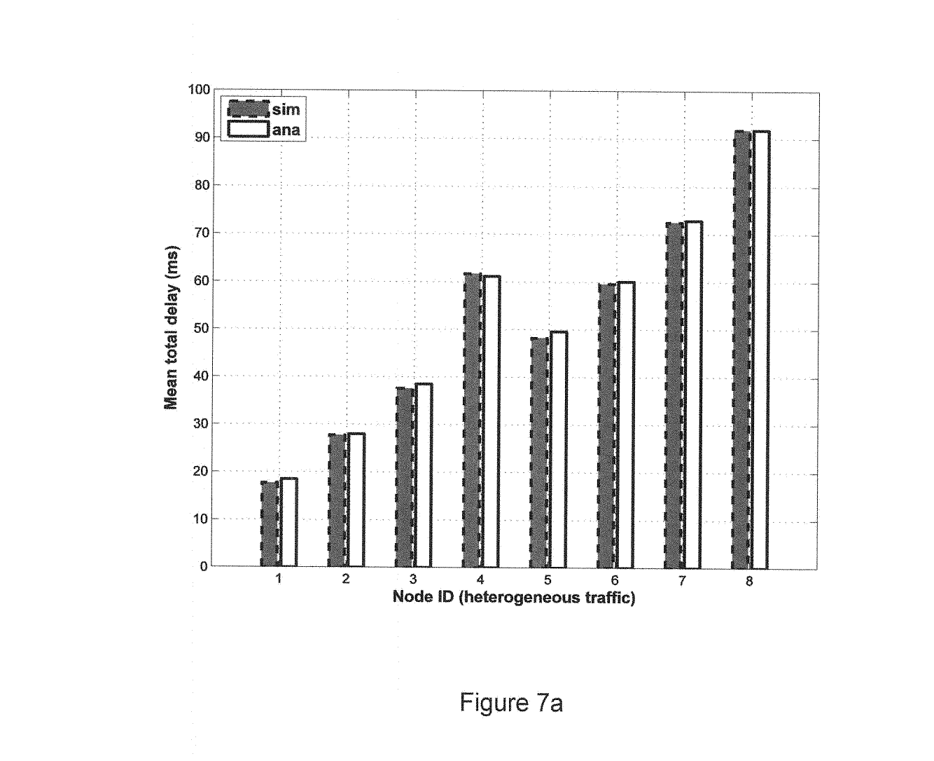

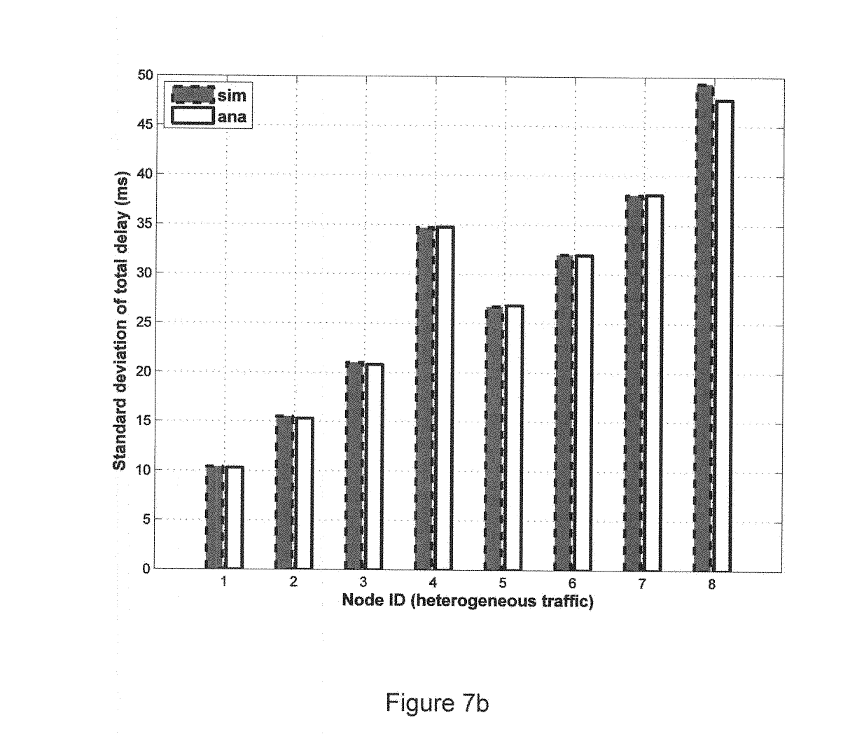

FIG. 7a plots the mean total delay (6) for each station and FIG. 7b plots the corresponding standard deviation (6), where the abscissa represents the station ID. The bar with dashed border represents the simulation results, while the bar with solid border represents the theoretical results. Note that the standard deviation of the total delay is same to that of the waiting delay since Tᵢ in (4) is a constant. From FIGS. 7a and 7b, each station has apparently different mean and variance of the delay since each station takes a very different parameter setting. The close match between the theoretical curves and the corresponding simulation curves manifests that embodiments of the present invention is very accurate in modelling heterogeneous setting.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A method for modelling delay performance of a communications protocol comprising the steps of:
applying a queuing model to a communications protocol having a power management scheme capable of affecting the delay performance of the communications protocol when in use; wherein the application of the queuing model to the communications protocol is arranged to model an operation of the communications protocol and the power management scheme so as to determine one or more operation intervals of the modelled operation of the communications protocol; and
calculating the delay performance with the one or more determined operation intervals.

2. The method for modelling delay performance in accordance with claim 1, wherein the queuing model is a pure limited service system model. 20

3. The method for modelling delay performance in accordance with claim 2, wherein the step of applying the pure limited service system model to the communications protocol to model an operation of the communications protocol includes a step of applying modelled parameters of the communications protocol to associated queuing parameters of the pure limited service system model.

4. The method for modelling delay performance in accordance with claim 3, wherein the one or more operation intervals include:
one or more delay intervals of each communication station's interaction with an access point;
one or more service time of the each communication station's interaction with the access point;
one or more waiting time of each communication station's interaction with the access point; or any one or more thereof.

5. The method for modelling delay performance in accordance with claim 4, wherein the queuing parameters of the pure limited service system model includes:
one or more vacation parameters representative of one or more vacation intervals; and
one or more service parameters representative of one or more service intervals.

6. The method for modelling delay performance in accordance with claim 5, wherein the modelled parameters of the communications protocol includes:
one or more actual polling intervals between an actual polling point of an associated station and its next actual or virtual polling point; and
one or more virtual polling interval between a virtual polling point of an associated station and its next actual or virtual polling point.

7. The method for modelling delay performance in accordance with claim 6, wherein the one or more operation intervals of the modelled operation of the communications protocol is determined with the one or more vacation parameters representative of one or more vacation intervals and the one or more virtual polling interval between a virtual polling point of an associated station and its next actual or virtual polling point.

8. The method for modelling delay performance in accordance with claim 7, wherein
the one or more vacation parameters of the queuing model is associated to the one or more virtual polling interval between a virtual polling point of an associated station and its next actual or virtual polling point;
the one or more service parameters is calculated by using the one or more actual polling intervals between an actual polling point of an associated station and its next actual or virtual polling point.

9. The method for modelling delay performance in accordance with claim 8, wherein the mathematical representation of the delay performance includes an average and deviation of the one or more delay intervals.

10. The method for modelling delay performance in accordance with claim 9, wherein the method is used in a network management process to model an operation of a computer or communication network.

11. The method for modelling delay performance in accordance with claim 10, wherein the communications protocol is a wireless communications protocol.

12. A system for modelling delay performance of a communications protocol comprising:
a modelling processor arranged to apply a queuing model to a communications protocol having a power management scheme capable of affecting the delay performance of the communications protocol when in use; wherein the application of the queuing model to the communications protocol is arranged to model an operation of the communications protocol and the power management scheme so as to determining one or more operation intervals of the modelled operation of the communications protocol; and
a calculating module arranged to calculate the delay performance with the one or more determined operation intervals.

13. The system for modelling delay performance in accordance with claim 12, wherein the queuing model is a pure limited service system model.

14. The method for modelling delay performance in accordance with claim 13, wherein the modelling processor applies the pure limited service system model to the communications protocol to model an operation of the communications protocol includes a step of applying modelled parameters of the communications protocol to associated queuing parameters of the pure limited service system model.

15. The system for modelling delay performance in accordance with claim 14, wherein the one or more operation intervals include:
one or more delay intervals of each communication station's interaction with an access point;
one or more service time of the each communication station's interaction with the access point;
one or more waiting time of each communication station's interaction with the access point; or any one or more thereof.

16. The system for modelling delay performance in accordance with claim 15, wherein the queuing parameters of the pure limited service system model includes:
one or more vacation parameters representative of one or more vacation intervals; and
one or more service parameters representative of one or more service intervals.

17. The system for modelling delay performance in accordance with claim 16, wherein the modelled parameters of the communications protocol includes:
one or more actual polling intervals between an actual polling point of an associated station and its next actual or virtual polling point; and
one or more virtual polling interval between a virtual polling point of an associated station and its next actual or virtual polling point.

18. The system for modelling delay performance in accordance with claim 17, wherein the one or more operation intervals of the modelled operation of the communications protocol is determined with the one or more vacation parameters representative of one or more vacation intervals and the one or more virtual polling interval between a virtual polling point of an associated station and its next actual or virtual polling point.

19. The system for modelling delay performance in accordance with claim 18, wherein
the one or more vacation parameters of the queuing model is associated to the one or more virtual polling interval between a virtual polling point of an associated station and its next actual or virtual polling point;
the one or more service parameters is calculated by using the one or more actual polling intervals between an actual polling point of an associated station and its next actual or virtual polling point.

20. The method for modelling delay performance in accordance with claim 19, wherein the method is used in a network management process to model an operation of a computer or communication network.
